(19) United States
(12) Patent Application Publication
(10) Pub. No.: US 2009/0190179 A1
(43) Pub. Date: Jul. 30, 2009

(54) Image Forming Device, Device Driver And Print Controlling Method

(75) Inventor: Mutsumi Takagi, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/354,627

(22) Filed: Jan. 15, 2009

(30) Foreign Application Priority Data
Jan. 24, 2008 (JP) 2008-013583

(51) Int. Cl. G06K 1/00

(52) U.S. Cl. 358/1.18

(57) ABSTRACT

There is described an image forming apparatus, which makes it possible to easily create a booklet sample. The apparatus includes: a determining section to determine whether or not instruction information for instructing the apparatus to create a booklet sample is attached to print data; and a controlling section to control the image forming apparatus to create the booklet sample in which at least a part of inner pages is printed in a predetermined mode. The predetermined mode includes any one of: a first mode in which all of the inner pages other than the front and the back cover sheets are made to be white papers; a second mode in which only the front and back cover sheets and specific inner pages are to be printed; and a third mode in which only the front and back cover sheets and initial pages of chapters are to be printed.

This application is based on Japanese Patent Application NO. 2008-013583 filed on Jan. 24, 2008, with Japan Patent Office, the entire content of which is hereby incorporated by reference.

### BACKGROUND OF THE INVENTION

The present invention relates to an image forming apparatus, a device driver and a print controlling method, and specifically relates to an image forming apparatus, a device driver and a print controlling method, for conducting operations for printing a booklet sample.

In recent years, there have been increasingly proliferated in the market various kinds of multi-functional apparatuses or the like, each provided with a combination of plural functions, such as a printer function, a scanner function, etc., (hereinafter, referred to as an image forming apparatus as a general term for each of them). Most of the above kinds of image forming apparatuses are provided with various kinds of post processing functions, such as a punching function, a stapling function, etc., so as to employ a method for processing a plurality of printed paper sheets into a booklet shape by using such the post processing functions and outputting the created booklet, when many paper sheets are printed. For instance, Tokkaihei 7-287428 (Japanese Non-Examined Patent Publication) sets forth a technology with respect to the creation of the print product shaped in the booklet.

In this connection, when crating a print product shaped in a booklet, the test printing operation for creating a test print product, called a booklet sample, is usually conducted in advance, so as to confirm its finished state. The created booklet sample is utilized for confirming the thickness and weight of the booklet, and the feel of a substance of the paper sheet, etc. Accordingly, the booklet sample is created by using the paper sheets being same as those to be employed for the practical printing.

When crating the booklet sample abovementioned, since it is a waste of toner to print all of the paper sheets, included in the booklet sample, based on the whole print data to be originally utilized for producing the booklet concerned, it is necessary to process the print data so as to make images on the pages, other than those on the front and back cover sheets, white.

However, since neither conventional image forming apparatuses nor conventional device drivers for controlling the image forming apparatuses are provided with a function for automatically creating print data to be exclusively utilized for printing the booklet sample, it is necessary for the user to operate the image forming apparatus concerned or the control device in which the device driver is installed in advance, so as to create the modified print data for printing the booklet sample from the original print data, by himself. Accordingly, there has been a problem that it is impossible to easily create the booklet sample.

### SUMMARY OF THE INVENTION

To overcome the abovementioned drawbacks in conventional printing systems, it is one of objects of the present invention to provide an image forming apparatus, a device driver and a print controlling method, each of which makes it possible to easily create a booklet sample.

Accordingly, at least one of the objects of the present invention can be attained by any one of the image forming apparatuses, the computer readable storage mediums and the print controlling methods, described as follows.
(1) According to an image forming apparatus reflecting an aspect of the present invention, the image forming apparatus to be controlled by a device driver, comprises: a determining section to determine whether or not instruction information for instructing the image forming apparatus to create a booklet sample, serving as a sample of a booklet-shaped print product, is attached to print data created by the device driver; and a controlling section to control the image forming apparatus according to the instruction information, so as to create the booklet sample in which at least a part of inner pages, other than a front cover sheet and a back cover sheet, is printed in a predetermined mode, when the determining section determines that the instruction information is attached to the print data.
(2) According to an image forming apparatus reflecting another aspect of the present invention, the image forming apparatus provided with a scanner function, comprises: a document reading section to read an original document by using the scanner function, so as to output image data representing the original document; an instructing section to issue an instruction to create a booklet sample, serving as a sample of a booklet-shaped print product; and a controlling section to control the image forming apparatus according to the instruction issued by the instructing section, so as to create the booklet sample in which at least a part of inner pages, other than a front cover sheet and a back cover sheet, is printed in a predetermined mode, based on the image data outputted by the document reading section, when the instructing section issues the instruction.
(3) According to a computer readable storage medium reflecting still another aspect of the present invention, the computer readable storage medium stores a computer executable program, serving as a device driver for controlling printing operations to be conducted by an image forming apparatus, the program being executable by a computer to cause the computer to perform a process comprising: making a display section display a screen for instructing the image forming apparatus to create a booklet sample, serving as a sample of a booklet-shaped print product; and attaching instruction information, for instructing the image forming apparatus to print at least a part of inner pages other than a front cover sheet and a back cover sheet in a predetermined mode, to print data, when the image forming apparatus is instructed to create the booklet sample from the screen.
(4) According to a computer readable storage medium reflecting still another aspect of the present invention, the computer readable storage medium stores a computer executable program, serving as a device driver for controlling printing operations to be conducted by an image forming apparatus, the program being executable by a computer to cause the computer to perform a process comprising: making a display section display a screen for instructing the image forming apparatus to create a booklet sample, serving as a sample of a booklet-shaped print product; and creating print data to be used for printing the booklet sample in which at least a part of inner pages, other than a front cover sheet and a back cover sheet, is printed in a predetermined mode, when the image forming apparatus is instructed to create the booklet sample from the screen.
(5) According to a print controlling method reflecting still another aspect of the present invention, the print controlling method to be employed in a system including an image forming apparatus and a control apparatus that controls the image forming apparatus, comprises: making a display section of the control apparatus display a screen for instructing the image forming apparatus to create a booklet sample, serving as a sample of a booklet-shaped print product; attaching instruction information, for instructing the image forming apparatus to print at least a part of inner pages other than a front cover sheet and a back cover sheet in a predetermined mode, to print data, when the image forming apparatus is instructed to create the booklet sample from the screen; transmitting the print data attached with or without the instruction information from the control apparatus to the image forming apparatus; determining whether or not the instruction information is attached to the print data received by the image forming apparatus; and creating the booklet sample according to the instruction information when determining that the instruction information is attached to the print data.
(6) According to a print controlling method reflecting still another aspect of the present invention, the print controlling method to be employed in an image forming apparatus that is provided with: a document reading section to read an original document by using a scanner function, so as to output image data representing the original document; and an instructing section to issue an instruction to create a booklet sample, serving as a sample of a booklet-shaped print product, comprises: controlling the image forming apparatus according to the instruction issued by the instructing section, so as to create the booklet sample in which at least a part of inner pages, other than a front cover sheet and a back cover sheet, is printed in a predetermined mode, based on the image data outputted by the document reading section, when the instructing section issues the instruction.
(7) According to a print controlling method reflecting still another aspect of the present invention, the print controlling method to be employed in a system including an image forming apparatus and a control apparatus that controls the image forming apparatus, comprises: making a display section of the control apparatus display a screen for instructing the image forming apparatus to create a booklet sample, serving as a sample of a booklet-shaped print product; creating print data to be used for printing the booklet sample in which at least a part of inner pages other than a front cover sheet and a back cover sheet is printed in a predetermined mode, when the image forming apparatus is instructed to create the booklet sample from the screen; transmitting the print data, created by the control apparatus, to the image forming apparatus; and creating the booklet sample in the image forming apparatus, based on the print data received from the control apparatus.
(8) According to still another aspect of the present invention, in the invention recited in any one of items 1-7, the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.
(9) According to yet another aspect of the present invention, in the invention recited in any one of items 1-8, the predetermined mode includes any one of: a fourth mode in which at least a single LD (Laser Diode) among a plurality of LDs to be employed for an exposing operation is deactivated; and a fifth mode in which printing operations are conducted by masking the print data for a predetermined region in a sub-scanning direction.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of a printing system embodied in the present invention as EMBODIMENT 1;

FIG. 2 shows a block diagram indicating a configuration of a controlling apparatus embodied in the present invention as EMBODIMENT 1;

FIG. 3 shows a block diagram indicating functions to be implemented by a device driver embodied in the present invention as EMBODIMENT 1;

FIG. 4 shows a block diagram indicating a configuration of an image forming apparatus embodied in the present invention as EMBODIMENT 1;

FIG. 5 shows a flowchart of controlling procedures to be conducted by a controlling apparatus embodied in the present invention as EMBODIMENT 1;

FIG. 6 shows a flowchart indicating operations to be conducted by an image forming apparatus embodied in the present invention as EMBODIMENT 1;

FIG. 7 shows a flowchart indicating operational procedures to be conducted for creating a booklet sample by an image forming apparatus embodied in the present invention as EMBODIMENT 1;

FIG. 8(a) and FIG. 8(b) show exemplary configurations of a screen (printer driver setting screen) to be displayed on a display section of a controlling apparatus embodied in the present invention as EMBODIMENT 1;

FIG. 9 shows an exemplary configuration of a print product shaped in a booklet;

FIG. 10 shows an exemplary configuration of a print product shaped in a booklet sample;

FIG. 11 shows a block diagram indicating a configuration of an image forming apparatus embodied in the present invention as EMBODIMENT 2;

FIG. 12 shows a flowchart indicating operations to be conducted by an image forming apparatus embodied in the present invention as EMBODIMENT 2; and

FIG. 13 shows a flowchart indicating operations to be conducted in a control apparatus embodied in the present invention as EMBODIMENT 3.

### DETAILED DESCRIPTION OF THE PREFERRED EMBODIMENT

As described in the “BACKGROUND OF THE INVENTION”, when processing a lot of printed paper sheets into a booklet shape and outputting the created booklets, a booklet sample is created in advance, so as to confirm the finished state of the print product shaped in a booklet. However, if the booklet sample is printed in the same manner as the practical print product shaped in a booklet, the toner is wasted in vain. To avoid such the waste of toner, when crating the booklet sample, it is necessary for the user to process the original print data by himself, so as to create the processed print data for printing the booklet sample. Accordingly, there has arisen a problem that it is impossible to easily create the booklet sample.

To overcome such the drawback, according to the first configuration of the printing system, embodied in the present invention, the device driver is provided with an instructing section to issue instruction information to create a booklet sample, so as to attach the instruction information to the print data and to transmit the print data attached with the instruction information to the image forming apparatus, in the case that the user instructs the device driver to create the booklet sample when creating the print data. Then, receiving the print data, the image forming apparatus creates the booklet sample according to the instruction information, when the instruction information is attached to the print data. According to the abovementioned, it becomes unnecessary for the user to create the print data to be used for the booklet sample every time when he wishes to create the booklet sample, and therefore, it becomes possible for the user to easily create the booklet sample. Further, since the print data to be used for creating the booklet sample is not newly created, it becomes possible not only to avoid such the problem that the data management becomes complicated and cumbersome due to the fact that plural kinds of print data are intermingled with each other, but also to prevent the original print data from being overwritten by other data in advance.

Further, according to the second configuration of the printing system, embodied in the present invention, the image forming apparatus is provided with an instructing section to issue an instruction to create a booklet sample, so as to create the booklet sample according to the instruction, in the case that the instructing section issues the instruction abovementioned, when conducting the printing operations based on the print data representing the original document read in advance. According to the abovementioned, it becomes unnecessary for the user to create the print data to be used for the booklet sample every time when he wishes to create the booklet sample, and therefore, it becomes possible for the user to easily create the booklet sample. Further, since the print data to be used for creating the booklet sample is not newly created, it becomes possible not only to avoid such the problem that the data management becomes complicated and cumbersome due to the fact that plural kinds of print data are intermingled with each other, but also to prevent the original print data from being overwritten by other data in advance.

Still further, according to the third configuration of the printing system, embodied in the present invention, the device driver is provided with an instructing section to issue an instruction to create a booklet sample, so as to create the print data to be used for the booklet sample and to transmit the created print data to the image forming apparatus, in the case that the instructing section issues the instruction when creating the print data. According to the abovementioned, it becomes unnecessary for the user to create the print data to be used for the booklet sample every time when he wishes to create the booklet sample, and therefore, it becomes possible for the user to easily create the booklet sample.

Still further, although, when creating the booklet sample, there has been employed such the method in which all of the inner pages other than the front and back cover sheets are made to be non-printed paper sheets, since the thickness, weight and the feel of a substance, possessed by the booklet sample including the non-printed paper sheets, are different from those of the practical booklet-shaped print product including the printed paper sheets, sometimes, it is difficult to confirm the finished state of the practical booklet-shaped print product from the booklet sample abovementioned. On the other hand, if all of the inner pages other than the front and back cover sheets were also printed for creating the booklet sample, toner would be wasted in vain.

To cope with such the abovementioned problem that toner is wasted in vain, Tokkai 2002-240403 (Japanese Non-Examined Patent Publication) sets forth the system configuration in which the image forming apparatus is provided with a toner saving mechanism having plural toner saving patterns, so that the first copy is printed by employing the plural toner saving patterns as the test print, and then, the user discriminates the printed image qualities to conduct the print setting operation for the second copy and the copies hereafter. However, according to Tokkai 2002-240403, since the toner saving operation is achieved by conducting the numerous arithmetic calculations for every one-dot of the laser beam, the processing becomes complicated, and there has arisen such a problem that the processing efficiency of the image forming apparatus is deteriorated considerably.

To solve such the problem as abovementioned, according to the third configuration of the printing system, embodied in the present invention, when printing the inner pages of the booklet sample, the toner saving operation is achieved by employing such a method that only a single LD (Laser Diode) among a plurality of LDs is activated, or the print data of a sub-scanning region is masked according to a rule determined in advance, etc. In other words, since the printed image quality of the booklet sample is not a matter of consideration as far as the finished state of the practical booklet-shaped print product can be confirmed from the booklet sample, the printing system is so constituted that the arithmetic calculations to be conducted for every one-dot of the laser beam can be omitted. Accordingly, it becomes possible to achieve the toner saving operation by employing a method simpler than ever, resulting in an improvement of the processing efficiency of the image forming apparatus concerned.

### Embodiment 1

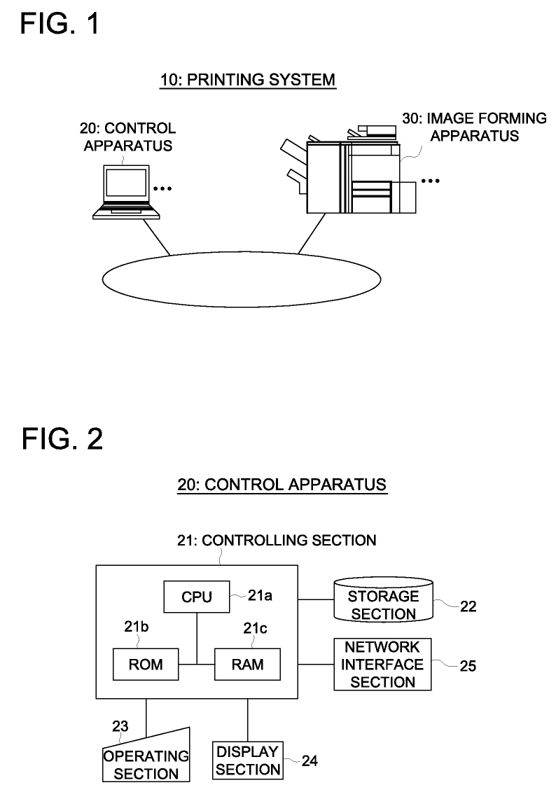

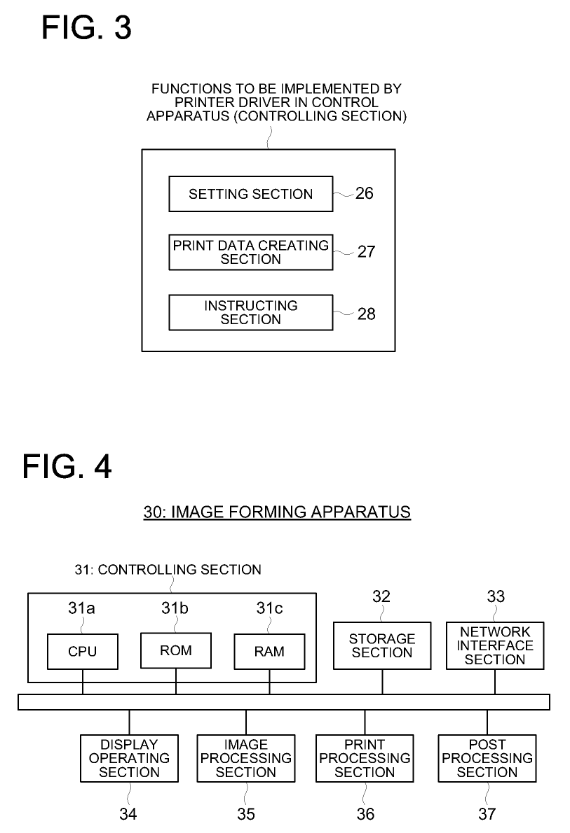

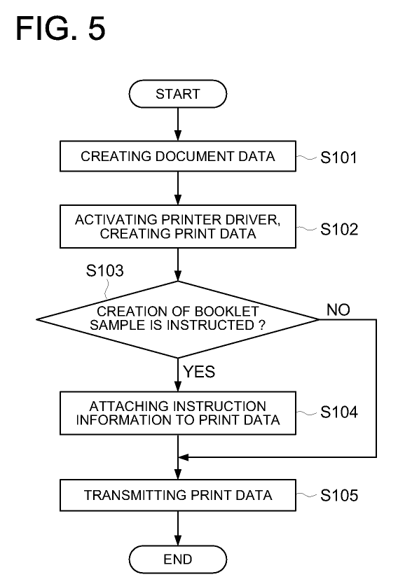

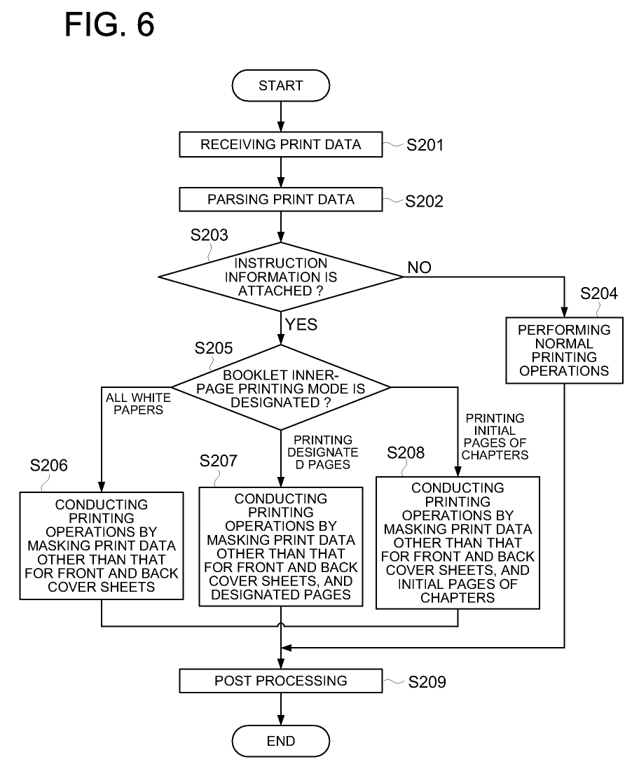

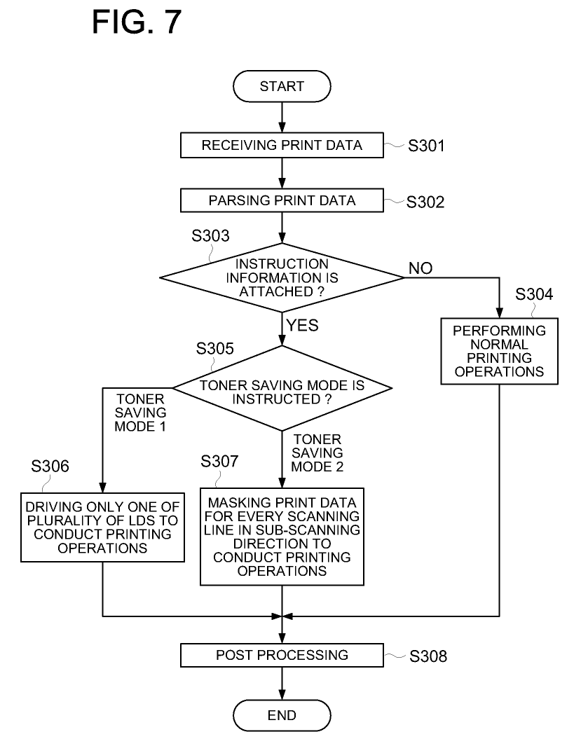

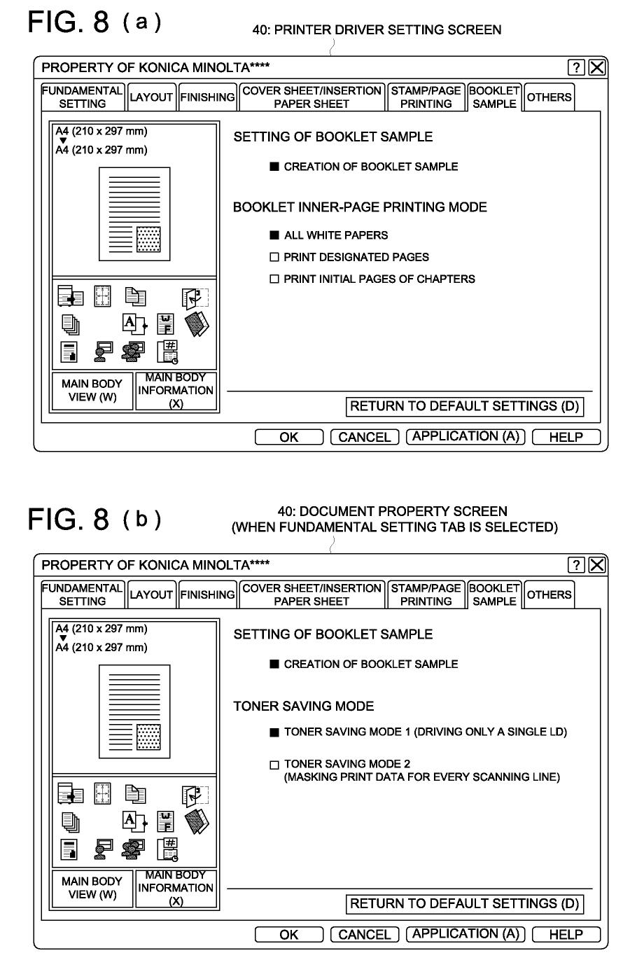

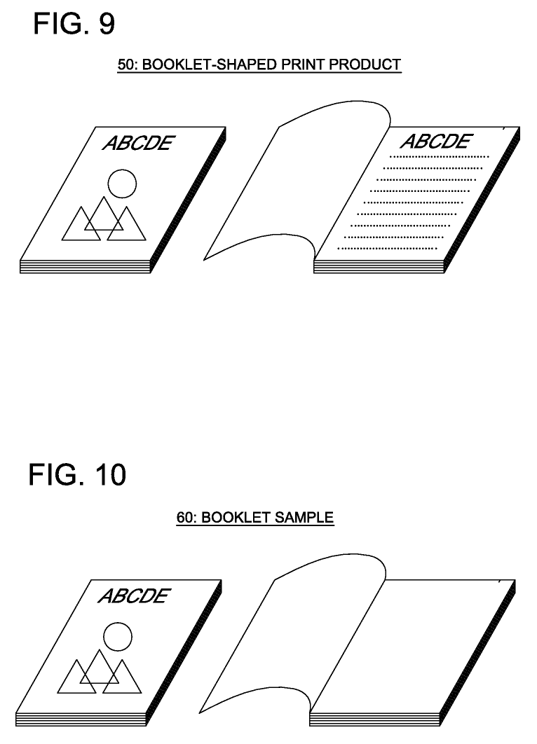

In order to describe the preferred embodiment of the present invention in detail, referring to FIG. 1 through FIG. 10, an image forming apparatus, a device driver and a print controlling method, embodied in the present invention, will be detailed in the following. FIG. 1 shows a schematic diagram of a configuration of the printing system embodied in the present invention, FIG. 2 shows a block diagram indicating a configuration of a controlling apparatus, FIG. 3 shows a block diagram indicating functions to be implemented by the device driver, and FIG. 4 shows a block diagram indicating a configuration of the image forming apparatus. Further, FIG. 5 shows a flowchart of the controlling procedures to be conducted by the controlling apparatus embodied in the present invention. Still further, FIG. 6 and FIG. 7 show flowcharts, each indicating operations to be conducted by the image forming apparatus embodied in the present invention. Still further, FIG. 8(a) and FIG. 8(b) show exemplary configurations of screens to be displayed on a display section of the controlling apparatus. Yet further, FIG. 9 and FIG. 10 show exemplary configurations of a print product shaped in a booklet and a booklet sample, respectively.

As shown in FIG. 1, a printing system 10, embodied in the present invention, is constituted by: a single or a plurality of client terminal devices (hereinafter, referred to as control apparatus 20), each of which instructs an image forming apparatus to conduct the operation for printing the print product shaped in a booklet or the booklet sample; and a single or a plurality of image forming apparatus 30, such as a printer, a digital compound apparatus (or a multi-functioned apparatus), etc., each of which implements the operation for printing the print product shaped in a booklet or the booklet sample, based on the instructions sent from the control apparatus 20. The single or the plurality of control apparatus 20 and the single or the plurality of image forming apparatus 30 are coupled to each other through a communication network, such as a LAN (Local Area Network), a WAN (Wide Area Network), etc.

Further, as shown in FIG. 2, the control apparatus 20 is provided with a controlling section 21, a storage section 22, an operating section 23, a display section 24, a network interface section 25, etc.

The controlling section 21 is constituted by a CPU (Central Processing Unit) 21a, a ROM (Read Only Memory) 21b, a RAM (Random Access Memory) 21c, etc., so as to read out various kinds of programs, such as an OS (Operating System), an application program for creating a document, a device driver for controlling the image forming apparatus 30 (hereinafter, referred to as a printer driver), etc., from the ROM 21b and/or the storage section 22 to develop them on the RAM 21c. Then, the CPU 21a executes the programs developed on the RAM 21c.

The storage section 22 is constituted by an HDD (Hard Disc Drive), etc., so as to store various kinds of programs and data therein.

The operating section 23 is constituted by a keyboard, a mouse, etc., so as to make it possible to conduct operations for setting various kinds of items in regard to a document creation and a printing (specifically, instructions for creating a booklet sample, etc.).

The display section 24 is constituted by a LCD (Liquid Crystal Display), etc., so as to display various kinds of screens, such as a printer driver setting screen, etc., for conducting operations for setting various kinds of items concerning to the printing (specifically, instructions for creating a booklet sample, etc.).

The network interface section 25 is constituted by a NIC (Network Interface Card), a modem, etc., so as to make it possible to communicate with the image forming apparatus 30.

Further, as shown in FIG. 3, the abovementioned printer driver makes the controlling section 21 of the control apparatus 20 serve as a setting section 26, a print data creating section 27, an instructing section 28, etc.

The setting section 26 makes the display section 24 display a screen from which the user can set items being user-settable for the image forming apparatus 30, such as paper sheet items in regard to a paper sheet feeding tray, a selection of a kind of paper sheet, etc., printing items in regard to a printing area, etc., post processing items in regard to a folding, a bookbinding, a stapling, etc., etc., (hereinafter, referred to as a printer driver setting screen). On that occasion, in the present embodiment, a button, a switch, etc., for instructing the creation of the booklet sample, is displayed on a predetermined position in the printer driver setting screen abovementioned.

The print data creating section 27 creates data (hereinafter, referred to as print data) that includes image data for every page and setting information in regard to the various kinds of abovementioned items and is written in the format of the PDL (Page Description Language). On that occasion, in the present embodiment, information instructing the creation of the booklet sample (hereinafter, referred to as instruction information) is attached to the predetermined area of the print data (for instance, a header area).

The instructing section 28 transmits the print data created by the print data creating section 27 to the image forming apparatus 30, in order to instruct the image forming apparatus 30 to create the print product shaped in a booklet or the booklet sample.

In this connection, although the personal computer serves as the control apparatus 20 in the configuration shown in FIG. 1, the scope of the control apparatus 20 is not limited to the personal computer. Any kind of apparatus can be employed as the control apparatus 20, as far as the concerned apparatus is capable of controlling the image forming apparatus 30. Further, although the printer driver serves as the setting section 26, the print data creating section 27 and the instructing section 28 in the configuration shown in FIG. 3, it is also applicable that at least one of them is structured as hardware to be provided in the control apparatus 20.

On the other hand, as shown in FIG. 4, the image forming apparatus 30 is constituted by a controlling section 31, a storage section 32, a network interface section 33, a display operating section 34, an image processing section 35, a print processing section 36, a post processing section 37, etc., which are coupled to each other through a bus.

The controlling section 31 is constituted by a CPU 31a, a ROM 31b, a RAM 31c, etc., so as to read out various kinds of programs from the ROM 31b and/or the storage section 32 to develop them on the RAM 31c. Then, the CPU 31a executes the programs developed on the RAM 31c. Specifically in the present embodiment, the controlling section 31 parses the print data received from the control apparatus 20, and then, serves as a determining section to determine whether the print data concerned is such data that instruct the creation of the print product shaped in the booklet or the creation of the booklet sample (namely, whether or not the instruction information is attached to the print data). When determining that the instruction information is attached to the print data, the controlling section 31 controls the concerning sections of the image forming apparatus 30 so as to create the booklet sample according to the instruction information concerned.

The storage section 32 is constituted by an HDD, etc., so as to store the programs for controlling the operations to be conducted in the image forming apparatus 30 and the print data acquired from the control apparatus 20.

The network interface section 33 is constituted by a NIC, a modem, etc., so as to make it possible to communicate with the control apparatus 20. In the present embodiment, the network interface section 33 receives the print data, etc., sent from the control apparatus 20.

The display operating section 34 is constituted by a display section, such as a LCD (Liquid Crystal Display), etc., and an operating section, such as a touch panel, etc., so as to display an icon and/or a key button on the LCD, etc., and to output operational signals inputted from the touch panel, etc., to the CPU 31a. In this connection, the display operating section 34 may be structured as either an integrated single section or a combination of the display section and the operating section separately provided.

The image processing section 35 generates image data representing images, each of which corresponds to each of the pages included in a booklet-shaped print product 50 or a booklet sample 60. Further, according to the instruction included in the print data, the image processing section 35 applies various kinds of image processing, such as a color conversion processing, a density adjustment processing, etc., to the created image data, as needed.

Based on the image data generated by the image processing section 35, the print processing section 36 prints the image onto the paper sheet. Concretely speaking, the print processing section 36 conducts such an image print processing that includes the steps of: forming an electrostatic latent image onto a circumferential surface of a photoreceptor drum by irradiating a light beam, modulated according to the image data and emitted from an exposing device, onto the photoreceptor drum uniformly charged by a charging device; developing the electrostatic latent image by employing a developing device for making charged toner adhere onto the photoreceptor drum so as to form a toner image on the circumferential surface of the photoreceptor drum; transferring the toner image onto the paper sheet through a primary transfer roller and a secondary transfer belt; and fixing the toner image onto the paper sheet by employing a fixing device.

The post processing section 37 performs the post processing, such as a folding, bookbinding, a stapling, etc. Then, the post processing section 37 outputs either a booklet-shaped print product 50 in which inner pages are fully printed in addition to its front and back cover sheets as shown in FIG. 9, or a booklet sample 60 in which only specific pages (for instance, only its front and back cover sheets) are printed as shown in FIG. 10.

In this connection, the configuration of the image forming apparatus 30 embodied in the present invention, shown in FIG. 4, is merely an example among various kinds of image forming apparatuses applicable for the present invention. Any kind of an image forming apparatus is applicable in the present invention, as far as either the booklet-shaped print product 50 or the booklet sample 60 is printable according to the instructions issued by the control apparatus 20. For instance, it is applicable that an ADF (Automatic Document Feeder) is added to the image forming apparatus 30. Further, although the image forming apparatus 30 includes the image processing section 35 in the present embodiment, it is also applicable that the processing operations to be conducted in the image processing section 35 are conducted in a RIP (Raster Image Processor) controller, etc., coupled to the image forming apparatus 30 through the communication network. In that case, the RIP controller parses print data so as to determine whether the instruction included in the print data concerned is to instruct the creation of the booklet-shaped print product 50 or to instruct the creation of the booklet sample 60.

The print controlling method to be employed in the printing system 10 configured as mentioned in the above will be detailed in the following.

Initially, referring to the flowchart shown in FIG. 5, the operations to be conducted by the control apparatus 20 embodied in the present invention will be detailed in the following.

In response to the operations conducted by the user, the controlling section 21 reads out the application program for creating a document from the ROM 21b or the storage section 22 to activate the application program. Then, the user creates document data representing images to be printed by using the document creation application program concerned (Step S101). In this connection, the scope of document data is not limited to the document data created in the above. It is also applicable that the document data is acquired from the ROM 21b or the storage section 22, or another computer terminal device, a server, etc., each of which is coupled to the control apparatus 20 through the communication network.

Successively, the user conducts predetermined operations on the screen displayed by the document creation application program concerned, so that the controlling section 21 activates the printer driver to make the printer driver (setting section 26) display a printer driver setting screen 40, as shown in FIG. 8(a), on the display section 24 (Step S102). On this printer driver setting screen 40, user-settable items to be inputted from the printer driver are categorized into tabs and displayed thereon. Accordingly, for instance, by clicking the booklet sample tab, a column for instructing the creation of the booklet sample, another column for selecting a printing mode of its inner pages, etc., are displayed on the screen, so that the user can determine whether or not the booklet sample should be created, and can conduct setting operations for instructing the control apparatus 20 how to print the inner pages of the booklet concerned. Then, after the user completes the various kinds of setting operations, by clicking the OK button, the printer driver (print data creating section 27) converts the document data to data written in the Page Description Language to create the print data.

Still successively, the printer driver (print data creating section 27) determines whether or not the creation of the booklet sample is instructed by the user (Step S103). When determining that the creation of the booklet sample is instructed, the printer driver attaches the instruction information for specifying (selecting) a booklet inner-page printing mode to a predetermined area in the print data (for instance, a header area) (Step S104). For instance, a printing mode in which all of the inner pages are made to be white papers, another printing mode in which only the designated pages are printed, still another printing mode in which only initial pages of chapters divided in advance are printed, etc., can be cited as the booklet inner-page printing mode.

Yet successively, the printer driver (instructing section 28) transmits the print data, which is created by the print data creating section 27 and to which the instruction information abovementioned is attached as needed, to the image forming apparatus 30 through the network interface section 25 (Step S105).

Next, referring to the flowchart shown in FIG. 6, the operations to be conducted in the image forming apparatus 30, embodied in the present invention, will be detailed in the following.

Initially, the controlling section 31 of the image forming apparatus 30 receives the print data sent from the control apparatus 20 through the network interface section 33 (Step S201).

Successively, the controlling section 31 parses the print data, so as to determine whether or not the instruction information for instructing the creation of the booklet sample is attached to the predetermined area (for instance, the header area) of the print data concerned (Step S202).

When determining that the instruction information is not attached to the predetermined area (Step S203; No), the controlling section 31 conducts the printing operations based on the print data in the normal printing mode. Concretely speaking, the image processing section 35 creates the image data representing all of the pages included in the booklet concerned, and then, based on the image data created by the image processing section 35, the print processing section 36 prints the images onto the paper sheets for every page.

On the other hand, when determining that the instruction information is attached to the predetermined area (Step S203; Yes), the controlling section 31 discriminates a kind of the booklet inner-page printing mode designated by the instruction information, so as to conduct the printing operations according to the kind of the booklet inner-page printing mode discriminated (Step S205). Concretely speaking, when the printing mode, in which all of the inner pages are made to be white papers, is designated, the printing operations are conducted by masking the print data for all of the inner pages other than the print data for the front and back cover sheets (Step S206). Further, when the other printing mode, in which only the designated pages are printed, is designated, the printing operations are conducted by masking print data for specific inner pages other than the front and back cover sheets, and other than the designated inner pages (Step S207). Still further, when still the other printing mode, in which only initial pages of chapters divided in advance are printed, is designated, the controlling section 31 discriminates partitioned pages that divide the chapters one by one, and conducts the printing operations by masking print data for specific inner pages other than the front and back cover sheets, and other than the partitioned pages that divide the chapters relative to each other (Step S208).

Still successively, the post processing section 37 performs the predetermined post processing to form the printed paper sheets into the booklet shape, and ejects either the booklet-shaped print product 50 or the booklet sample 60 (Step S209).

In this connection, although only the specific inner pages, other than the front and back cover sheets, the designated pages and/or the initial pages of the chapters divided in advance, are made to be white papers in the flowchart mentioned in the above, the thickness and the weight of the printed paper sheet after printed by the image forming apparatus employing the electro-photographic method, slightly increases, compared to those of the white paper sheet. Accordingly, it has been impossible for the user to accurately grasp the thickness and the weight of whole booklet by employing the booklet sample 60 in which all of the inner pages are made to be white papers. Further, it has been also impossible for the user to grasp the feel of a substance to be acquired from the whole booklet merely by employing the booklet sample 60 in which all of the inner pages are made to be white papers. On the other hand, if the all pages of the booklet sample 60 are printed with such a quality that is same as that of the pages to be included in the practical booklet, the increase of the toner consumption would result in an increase of the production cost. However, since the booklet sample 60 is not employed as a sample for confirming the details written in the inner pages, no problem will arise even if the image quality is deteriorated to a certain extent. Therefore, in order to suppress the consumption of the toner, while to make it possible to grasp the thickness and the weight of whole booklet as well as the feel of a substance more accurately than ever, it is also possible to configure the image forming apparatus 30 so as to print all of the inner pages in a predetermined toner saving mode.

For instance, when the exposing device of the print processing section 36 is constituted by a plurality of LDs (Laser Diode), the toner saving mode is established by deactivating at least one of the plurality of LDs (it is preferable that only an arbitral one of the plurality of LDs is activated). Alternatively, when the exposing device of the print processing section 36 is constituted by a plurality of LEDs (Light Emitting Diode), since it is impossible to employ the abovementioned toner saving mode for the plurality of LEDs, the other toner saving mode would be established, in which enable signals for controlling the sub-scanning method are generated, so as to apply the data masking operation to a predetermined area in the sub-scanning direction (preferably, for every scanning line). In this connection, this toner saving mode is also effective for the case that the exposing device is constituted by the plurality of LDs, instead of the plurality of LEDs.

Further, the method for implementing the abovementioned toner saving mode will be detailed in the following. At first, the controlling section 21 (setting section 26) of the control apparatus 20 makes the display section 24 display the printer driver setting screen 40 as shown in FIG. 8(b), so that the user can select any one of a toner saving mode 1 in which only a single LD among a plurality of LDs is driven and a toner saving mode 2 in which the print data is masked for every scanning line. Then, the controlling section 21 (print data creating section 27) attaches instruction information for specifying the toner saving mode selected by the user (toner saving mode 1 or toner saving mode 2) to the predetermined area of the print data (for instance, the header area).

Successively, as indicated in the flowchart shown in FIG. 7, the controlling section 31 of the image forming apparatus 30 receives and parses the print data, so as to determine whether or not the instruction information for instructing the creation of the booklet sample is attached to the predetermined area of the print data (for instance, the header area) (Step S301 and Step S302).

When determining that the instruction information is not attached (Step S303; No), the controlling section 31 makes the print processing section 36 perform the normal printing operations based on the print data received (Step S304). When determining that the instruction information is attached (Step S303; Yes), the controlling section 31 discriminates the toner saving mode instructed by the instruction information (Step S305). When determining that the toner saving mode 1 is instructed, the controlling section 31 drives only an arbitral one of the plurality of LDs to conduct the printing operations (Step S306), while, when determining that the toner saving mode 1 is instructed, the controlling section 31 masks the print data for every scanning line in the sub-scanning direction to conduct the printing operations (Step S307).

Successively, the post processing section 37 performs the predetermined post processing to form the printed paper sheets into the booklet shape, and ejects either the booklet-shaped print product 50 or the booklet sample 60 (Step S308).

As described in the foregoing, according to the present embodiment, the printer driver (setting section 26) displays the booklet sample setting screen within the printer driver setting screen 40, and the printer driver (print data creating section 27) attaches the instruction information for instructing the creation of the booklet sample to the print data, so as to transmit the print data attached with the instruction information to the image forming apparatus 30, while the controlling section 31 of the image forming apparatus 30 parses the print data received from the control apparatus 20, so as to create the booklet sample 60 according to the contents of the instruction information, when determining that the instruction information is attached to the print data. Therefore, according to the present invention, it becomes unnecessary for the user to create the print data to be used for the booklet sample every time when the booklet sample 60 should be created, and accordingly, it becomes possible for the user to easily create the booklet sample. Further, since the system is so constituted that the instruction information is attached to the predetermined area of the print data, it becomes possible not only to make the data management easy without intermingling the print data for the booklet-shaped print product 50 and the other print data for the booklet sample 60 with each other, but also to prevent the print data for the booklet-shaped print product 50 from being overwritten by other data in advance.

In this connection, although the case that the printing operation is performed in of one of the three printing modes, including the printing mode in which all of the inner pages are made to be white papers, the other printing mode in which only the designated pages are printed and still the other printing mode in which only initial pages of chapters divided in advance are printed, and the other case that the printing operation is performed by selecting one of the two printing modes, including the toner saving mode 1 in which only a single LD among a plurality of LDs is driven to print all of the inner pages and the toner saving mode 2 in which the print data is masked for every scanning line, are exemplified in the embodiment described in the foregoing, it is also applicable that the system is so constituted that the abovementioned two cases are combined with each other so as to print at least a part of the inner pages in the toner saving mode.

### Embodiment 2

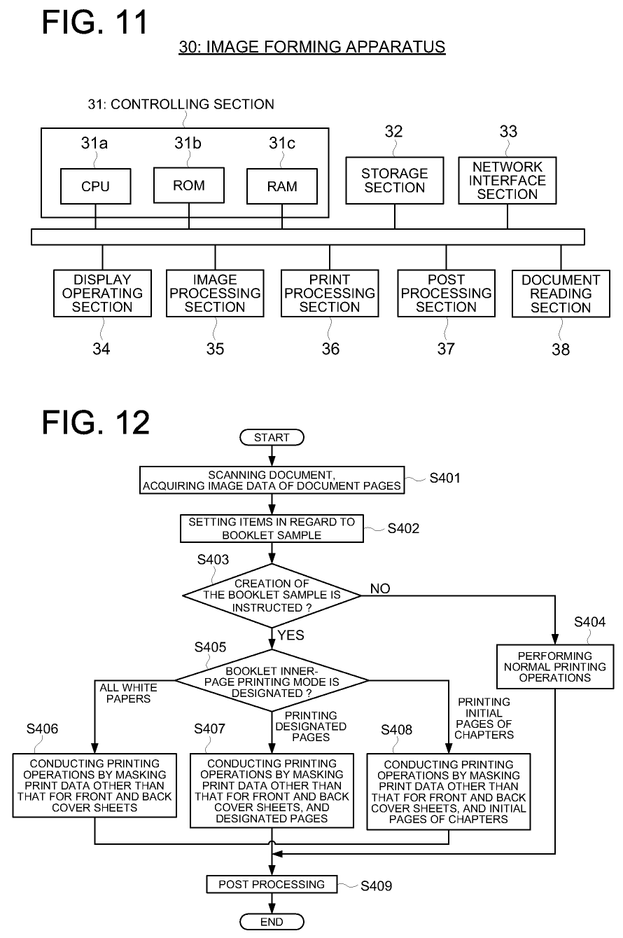

Next, referring to FIG. 11 and FIG. 12, the image forming apparatus and the print controlling method embodied in the present invention as EMBODIMENT 2, will be detailed in the following. FIG. 11 shows a block diagram indicating a configuration of an image forming apparatus of EMBODIMENT 2, while FIG. 12 shows a flowchart indicating operations to be conducted in the image forming apparatus of EMBODIMENT 2.

Although the case in which the printer driver of the control apparatus 20 instructs the image forming apparatus 30 to perform the printing operations (in other words, the image forming apparatus 30 serves as a network printer) is exemplified in EMBODIMENT 1 described in the foregoing, the case in which the image forming apparatus 30 reads an original document, and then, outputs the booklet-shaped print product 50 will be detailed in the following EMBODIMENT 2 of the present invention.

In that case, in addition to the constituents included in the configuration of the EMBODIMENT 1 shown in FIG. 4, the image forming apparatus 30 further includes a document reading section 38 that is constituted by a light source for scanning the document, a CCD (Charge Coupled Device) image sensor for converting a light reflected from the document to electric signals and an analogue to digital converter for converting analogue signals to digital signals, etc., as shown in FIG. 11. Further, the controlling section 31 also serves as a setting section to make the display operating section 34 display a screen for setting the items in regard to the creation of the booklet sample, while the display operating section 34 also serves as an instructing section to instruct the creation of the booklet sample.

In this connection, it is applicable that the abovementioned setting section is configured as either hardware or a control program to be executed on the image forming apparatus 30 by a computer, so as to function the computer as the setting section.

Next, referring to the flowchart shown in FIG. 12, the operations to be conducted by the image forming apparatus 30 embodied in the present invention as EMBODIMENT 2, will be detailed in the following.

Initially, when the user operates the display operating section 34 to input an instruction for reading a printed document, the document reading section 38 scans the document to acquire image data of images respectively printed on the pages included in the document (Step S401). In this connection, it is also applicable to read out the document data stored in advance in the storage section 32, etc., instead of scanning the document.

Successively, the setting section of the controlling section 31 makes the display operating section 34 display the setting screen for setting the items in regard to the booklet sample, thereon (Step S402). Although the layout of the setting screen may be arbitrarily established, the setting screen can be constituted by a column for instructing the creation of the booklet sample, another column for selecting the printing mode of the inner pages of the booklet concerned and/or the toner saving mode, etc., as well as the screen layout shown in FIG. 8(a) and FIG. 8(b). Then, the user sets the various kinds of items, such as whether or not the booklet sample should be created, how to print the inner pages of the booklet, what kind of toner saving mode should be employed, etc.

Still successively, the controlling section 31 determines whether or not the creation of the booklet sample is instructed (Step S403). When determining that the creation of the booklet sample is not instructed (Step S403; No), the controlling section 31 makes the print processing section 36 conduct the normal printing operations (Step S404), while When determining that the creation of the booklet sample is instructed (Step S403; Yes), the controlling section 31 discriminates a kind of the booklet inner-page printing mode (Step S405). When the controlling section 31 discriminates that the booklet inner-page printing mode is such a printing mode in which all of the inner pages are made to be white papers, the printing operations are conducted by masking the print data for all of the inner pages other than the print data for the front and back cover sheets (Step S406). Further, when the controlling section 31 discriminates that the booklet inner-page printing mode is such a printing mode in which only the designated pages are printed, the printing operations are conducted by masking print data for specific inner pages other than the front and back cover sheets, and other than the designated inner pages (Step S407). Still further, when the controlling section 31 discriminates that the booklet inner-page printing mode is such a printing mode in which only initial pages of chapters divided in advance are printed, the printing operations are conducted by masking print data for specific inner pages other than the front and back cover sheets, and other than the partitioned pages that divide the chapters one another (Step S408). Yet further, when the toner saving mode is established, the controlling section 31 discriminates the toner saving mode. When determining that the toner saving mode 1 is instructed, the printing operations are conducted by deactivating at least one of the plurality of LDs (preferably, by driving only an arbitral one of the plurality of LDs), while, when determining that the toner saving mode 2 is instructed, the printing operations are conducted by masking the print data in a predetermined area of the sub-scanning direction (preferably, for every scanning line in the sub-scanning direction).

Yet successively, the post processing section 37 performs the predetermined post processing to form the printed paper sheets into the booklet shape, and ejects either the booklet-shaped print product 50 or the booklet sample 60 (Step S409).

As described in the foregoing, according to EMBODIMENT 2, the controlling section 31 (setting section) of the image forming apparatus 30 makes the display operating section 34 display the setting screen of the booklet sample thereon, and, when the creation of the booklet sample is instructed, the controlling section 31 conducts the printing operations for creating the booklet sample 60. Therefore, according to the present invention, it becomes unnecessary for the user to create the print data to be used for the booklet sample every time when the booklet sample 60 should be created, and accordingly, it becomes possible for the user to easily create the booklet sample.

In this connection, it is also applicable in EMBODIMENT 2 that the system is so constituted that the inner page printing mode and the toner saving mode are combined with each other so as to print at least a part of the inner pages in the toner saving mode.

### Embodiment 3

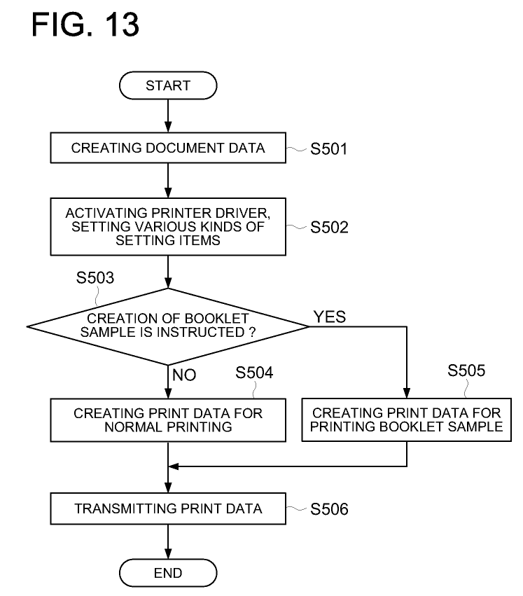

Next, referring to FIG. 13, the image forming apparatus, the device driver and the print controlling method, embodied in the present invention as EMBODIMENT 3, will be detailed in the following. FIG. 13 shows a flowchart indicating operations to be conducted in the control apparatus of EMBODIMENT 3.

In the abovementioned EMBODIMENT 1, the system is so constituted that the instruction information for instructing the creation of the booklet sample is attached to the print data when generating the print data by employing the device driver (printer driver) of the control apparatus 20. Further, in the EMBODIMENT 3, the explanations, in regard to the case in which the print data to be used for creating the booklet sample are generated, will be given in the following.

In that case, although the configuration of the control apparatus 20 in EMBODIMENT 3 is same as those in EMBODIMENT 1 shown in FIG. 2 and FIG. 3, the print data creating section 27 of the controlling section 21 generates such the print data to be used for creating the booklet sample that makes inner pages, other than the front and back cover sheets, the designated pages and the initial pages of the chapters divided in advance, white papers. In this connection, it is applicable that the print data creating section 27 is configured as hardware equipped in the control apparatus 20.

Next, referring to the flowchart shown in FIG. 13, the operations to be conducted in the control apparatus 20, embodied in the present invention as EMBODIMENT 3, will be detailed in the following.

Initially, the user creates the document data representing the printing object by using the document creation application program concerned (Step S501). In this connection, the scope of document data is not limited to the document data created in the above. It is also applicable that the document data is acquired from the ROM 21b or the storage section 22, or another computer terminal device, a server, etc., each of which is coupled to the control apparatus 20 through the communication network.

Successively, the user conducts predetermined operations on the screen displayed by the document creation application program concerned, so that the controlling section 21 activates the printer driver to make the printer driver (setting section 26) display a printer driver setting screen 40, as shown in FIG. 8(a) and FIG. 8(b) on the display section 24 (Step S502). Then, the user conducts setting operations for determining whether or not the booklet sample should be created, determining how to print the inner pages of the booklet concerned, selecting a kind of toner saving mode to be employed for the printing operations, etc., (Step S502).

Still successively, the printer driver (print data creating section 27) determines whether or not the creation of the booklet sample is instructed by the user (Step S503). When determining that the creation of the booklet sample is not instructed (Step S503; No), the print data creating section 27 creates such print data that is to be used for printing a normal booklet-shaped print product. On the other hand, when determining that the creation of the booklet sample is instructed (Step S503; Yes), the print data creating section 27 generates such the print data to be used for creating the booklet sample that makes inner pages, other than the front and back cover sheets, the designated pages and the initial pages of the chapters, white papers, or the other print data to be used for creating the booklet sample that makes the image forming apparatus 30 print the inner pages of the concerned booklet sample in the toner saving mode (Step S505).

Still successively, the printer driver (instructing section 28) transmits the print data to be used for creating the normal booklet-shaped print product or the booklet sample, which is created by the print data creating section 27, to the image forming apparatus 30 through the network interface section 25 (Step S506).

Yet successively, receiving the print data sent from the control apparatus 20, the image forming apparatus 30 creates the booklet-shaped print product 50 or the booklet sample 60, according to the instruction included in the print data concerned.

As described in the foregoing, according to EMBODIMENT 3, the printer driver (setting section 26) displays the booklet sample setting screen within the printer driver setting screen 40, and the printer driver (print data creating section 27) generates the print data to be used for creating the booklet sample, when the creation of the booklet sample is instructed and transmits the generated print data to the image forming apparatus 30, while the image forming apparatus 30 creates the booklet-shaped print product 50 or the booklet sample 60, according to the instruction included in the print data received from the control apparatus 20. Therefore, according to the present invention, it becomes unnecessary for the user to create the print data to be used for the booklet sample every time when the booklet sample 60 should be created, and accordingly, it becomes possible for the user to easily create the booklet sample.

In this connection, it is also applicable in EMBODIMENT 3 that the system is so constituted that the inner page printing mode and the toner saving mode are combined with each other so as to print at least a part of the inner pages in the toner saving mode.

Further, although the case that the printing operation is performed in of one of the three printing modes, including the printing mode in which all of the inner pages are made to be white papers, the other printing mode in which only the designated pages are printed and still the other printing mode in which only initial pages of chapters are printed, and the other case that the printing operation is performed by selecting one of the two printing modes, including the mode in which only a single LD among a plurality of LDs is driven and the other mode in which the print data is masked for every scanning line, are exemplified in the embodiments described in the foregoing, it is also applicable that the system is so constituted that at least a part of the inner pages included in the booklet sample is printable in a certain mode being different from the mode employed for printing the booklet-shaped print product 50.

Still further, although the embodiments, each of which creates the booklet sample 60, have been described in the foregoing, the scope of the present invention is not limited to the above described embodiments. The present invention can be applied to an arbitral test printing as well.

The present invention is available for a device driver to be executed in a control apparatus, an image forming apparatus that implements printing operations and a print controlling method.

According to the image forming apparatus, the device driver and the print controlling method, it becomes possible to easily create a booklet sample.

This is because, the device driver is provided with an instructing section to issue instruction information to create a booklet sample, so as to attach the instruction information to the print data and to transmit the print data attached with the instruction information to the image forming apparatus, when the user instructs the device driver to create the booklet sample. Then, receiving the print data, the image forming apparatus conducts controlling operations to create the booklet sample according to the instruction information, when the instruction information is attached to the print data.

Further, this is because, the image forming apparatus is provided with an instructing section to issue an instruction to create a booklet sample, and conducts controlling operations, so as to create the booklet sample according to the instruction, when the creation of the booklet sample is instructed.

Still further, this is because, the device driver is provided with an instructing section to issue an instruction to create a booklet sample, so as to create the print data to be used for creating the booklet sample and to transmit the created print data to the image forming apparatus, when the user instructs the device driver to create the booklet sample. Then, receiving the print data, the image forming apparatus conducts controlling operations to create the booklet sample based on the print data received, when the creation of the booklet sample is instructed.

While the preferred embodiments of the present invention have been described using specific term, such description is for illustrative purpose only, and it is to be understood that changes and variations may be made without departing from the spirit and scope of the appended claims.

What is claimed is:

1. An image forming apparatus to be controlled by a device driver, comprising:
a determining section to determine whether or not instruction information for instructing the image forming apparatus to create a booklet sample, serving as a sample of a booklet-shaped print product, is attached to print data created by the device driver; and
a controlling section to control the image forming apparatus according to the instruction information, so as to create the booklet sample in which at least a part of inner pages, other than a front cover sheet and a back cover sheet, is printed in a predetermined mode, when the determining section determines that the instruction information is attached to the print data.

2. The image forming apparatus of claim 1,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

3. The image forming apparatus of claim 1,
wherein the predetermined mode includes any one of: a fourth mode in which at least a single LD (Laser Diode) among a plurality of LDs to be employed for an exposing operation is deactivated; and a fifth mode in which printing operations are conducted by masking the print data for a predetermined region in a sub-scanning direction.

4. An image forming apparatus provided with a scanner function, comprising:
a document reading section to read an original document by using the scanner function, so as to output image data representing the original document;
an instructing section to issue an instruction to create a booklet sample, serving as a sample of a booklet-shaped print product; and
a controlling section to control the image forming apparatus according to the instruction issued by the instructing section, so as to create the booklet sample in which at least a part of inner pages, other than a front cover sheet and a back cover sheet, is printed in a predetermined mode, based on the image data outputted by the document reading section, when the instructing section issues the instruction.

5. The image forming apparatus of claim 4,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

6. The image forming apparatus of claim 4,
wherein the predetermined mode includes any one of: a fourth mode in which at least a single LD (Laser Diode) among a plurality of LDs, to be employed for an exposing operation, is deactivated; and a fifth mode in which printing operations are conducted by masking print data for a predetermined region in a sub-scanning direction, wherein the print data is derived from the image data.

7. A computer readable storage medium storing a computer executable program, serving as a device driver for controlling printing operations to be conducted by an image forming apparatus, the program being executable by a computer to cause the computer to perform a process comprising:
making a display section display a screen for instructing the image forming apparatus to create a booklet sample, serving as a sample of a booklet-shaped print product; and
attaching instruction information, for instructing the image forming apparatus to print at least a part of inner pages other than a front cover sheet and a back cover sheet in a predetermined mode, to print data, when the image forming apparatus is instructed to create the booklet sample from the screen.

8. The computer readable storage medium of claim 7,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

9. The computer readable storage medium of claim 7,
wherein the predetermined mode includes any one of: a fourth mode in which at least a single LD (Laser Diode) among a plurality of LDs to be employed for an exposing operation is deactivated; and a fifth mode in which printing operations are conducted by masking the print data for a predetermined region in a sub-scanning direction.

10. A computer readable storage medium storing a computer executable program, serving as a device driver for controlling printing operations to be conducted by an image forming apparatus, the program being executable by a computer to cause the computer to perform a process comprising:
making a display section display a screen for instructing the image forming apparatus to create a booklet sample, serving as a sample of a booklet-shaped print product; and
creating print data to be used for printing the booklet sample in which at least a part of inner pages, other than a front cover sheet and a back cover sheet, is printed in a predetermined mode, when the image forming apparatus is instructed to create the booklet sample from the screen.

11. The computer readable storage medium of claim 10,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

12. The computer readable storage medium of claim 10,
wherein the predetermined mode includes any one of: a fourth mode in which at least a single LD (Laser Diode) among a plurality of LDs to be employed for an exposing operation is deactivated; and a fifth mode in which printing operations are conducted by masking the print data for a predetermined region in a sub-scanning direction.

13. A print controlling method to be employed in a system including an image forming apparatus and a control apparatus that controls the image forming apparatus, the method comprising:
making a display section of the control apparatus display a screen for instructing the image forming apparatus to create a booklet sample, serving as a sample of a booklet-shaped print product;
attaching instruction information, for instructing the image forming apparatus to print at least a part of inner pages other than a front cover sheet and a back cover sheet in a predetermined mode, to print data, when the image forming apparatus is instructed to create the booklet sample from the screen;
transmitting the print data attached with or without the instruction information from the control apparatus to the image forming apparatus;
determining whether or not the instruction information is attached to the print data received by the image forming apparatus; and
creating the booklet sample according to the instruction information when determining that the instruction information is attached to the print data.

14. The print controlling method of claim 13,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

15. The print controlling method of claim 13,
wherein the predetermined mode includes any one of: a fourth mode in which at least a single LD (Laser Diode) among a plurality of LDs to be employed for an exposing operation is deactivated; and a fifth mode in which printing operations are conducted by masking the print data for a predetermined region in a sub-scanning direction.

16. A print controlling method to be employed in an image forming apparatus that is provided with: a document reading section to read an original document by using a scanner function, so as to output image data representing the original document; and an instructing section to issue an instruction to create a booklet sample, serving as a sample of a booklet-shaped print product; the method comprising:
controlling the image forming apparatus according to the instruction issued by the instructing section, so as to create the booklet sample in which at least a part of inner pages, other than a front cover sheet and a back cover sheet, is printed in a predetermined mode, based on the image data outputted by the document reading section, when the instructing section issues the instruction.

17. The print controlling method of claim 16,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

18. The print controlling method of claim 16,
wherein the predetermined mode includes any one of: a fourth mode in which at least a single LD (Laser Diode) among a plurality of LDs, to be employed for an exposing operation, is deactivated; and a fifth mode in which printing operations are conducted by masking print data for a predetermined region in a sub-scanning direction, wherein the print data is derived from the image data.

19. A print controlling method to be employed in a system including an image forming apparatus and a control apparatus that controls the image forming apparatus, the method comprising:
making a display section of the control apparatus display a screen for instructing the image forming apparatus to create a booklet sample, serving as a sample of a booklet-shaped print product;
creating print data to be used for printing the booklet sample in which at least a part of inner pages other than a front cover sheet and a back cover sheet is printed in a predetermined mode, when the image forming apparatus is instructed to create the booklet sample from the screen;
transmitting the print data, created by the control apparatus, to the image forming apparatus; and
creating the booklet sample in the image forming apparatus, based on the print data received from the control apparatus.

20. The print controlling method of claim 19,
wherein the predetermined mode includes any one of: a first mode in which all of the inner pages other than the front cover sheet and the back cover sheet, included in the booklet sample, are made to be non-printed paper sheets; a second mode in which only the front cover sheet, the back cover sheet and a specific inner page determined in advance, are to be printed; and a third mode in which only the front cover sheet, the back cover sheet and an initial page of each of chapters divided in advance, are to be printed.

21. The print controlling method of claim 19,
wherein the predetermined mode includes any one of: a fourth mode in which at least a single LD (Laser Diode) among a plurality of LDs to be employed for an exposing operation is deactivated; and a fifth mode in which printing operations are conducted by masking the print data for a predetermined region in a sub-scanning direction.
